(19) United States
(12) Patent Application Publication
(10) Pub. No.: US 2013/0242723 A1
(43) Pub. Date: Sep. 19, 2013

(54) DATA PROCESSING APPARATUS, DATA TRANSCEIVER APPARATUS, AND METHOD FOR CONTROLLING DATA TRANSMISSION AND RECEPTION

(71) Applicant: FUJITSU LIMITED, Kawasaki-shi (JP)

(72) Inventors: Kazuki HYOUDOU, Chofu (JP); Osamu Shiraki, Kawasaki (JP)

(73) Assignee: FUJITSU LIMITED, KAWASAKI-SHI (JP)

(21) Appl. No.: 13/757,909

(22) Filed: Feb. 4, 2013

(30) Foreign Application Priority Data
Mar. 15, 2012 (JP) 2012-059456

(51) Int. Cl. H04L 12/24

(52) U.S. Cl. CPC H04L 41/0654
USPC 370/225; 370/243

(57) ABSTRACT

A relay device is capable of associating a plurality of network-side ports to a server-side port connected to an adapter 310 of a server 300. The relay device detects a failure and recovery from the failure as events for each of the network-side ports associated with the server-side port, and transmits to the server 300 a control frame indicating the network-side port in which the event was detected and the type of the event. The control frame is received by the adapter 310, and is processed by a link status management unit 320. The link status management unit 320 individually turns on/off an associated virtual interface 312a among virtual interfaces 312a configured on a virtual layer unit 312, in accordance with the control frame.

### CROSS-REFERENCE TO RELATED APPLICATION

This application is based upon and claims the benefit of priority of the prior Japanese Patent Application No. 2012-059456, filed on Mar. 15, 2012, the entire contents of which are incorporated herein by reference.

### FIELD

The embodiments described herein are related to a technique by which a data processing apparatus transmits and receives data via a port.

### BACKGROUND

According to a conventional technique, relay devices (switches) are arranged between servers (data processing apparatuses) and a network. As such relay devices, a relay device that can arbitrarily set connection relationships between network-side ports and server-side ports is sometimes used. By arranging this type of relay device between servers and a network, servers can transmit and receive data to and from an arbitrary network.

A relay device is provided with a function of detecting as events failures that occurred in a connected network (link down). A relay device provided with such a detection function reports the occurrence of a failure through a server-side port associated with a port connected to the network in which the failure was detected. The reporting is performed by, for example, disconnecting that server-side port. By this report, a server connected to a network in which a failure was detected can respond to that failure via the relay device. Accordingly, the ability to make appropriate responses to a result of failure (event) detection by the relay device is considered necessary for a data processing apparatus such as a server connected to a relay device for detecting failures.

In recent years, the virtualization technique has been applied, and a plurality of virtual links are assigned to a single physical link through which data is transmitted and received. A server to which such virtualization technique has been applied can transmit and receive data through a single port by using a plurality of virtual links.

Some relay devices as described above are compatible with servers to which the virtualization technique is applied for transmission and reception (communication) of data. Such a relay device can associate a plurality of network-side ports with a server-side port to which one port of a server is connected.

When a plurality of network-side ports are associated with a server-side port to which one of the ports of a server is connected in a relay device, an arrangement is employed in which a plurality of networks are connected to one of the ports of that server. In view of this, it is desired that such a connection arrangement be taken into consideration when responding to failures (events) occurring in a network.
Patent Document 1: Japanese Laid-open Patent Publication No. 2010-283811
Patent Document 2: Japanese Laid-open Patent Publication No. 09-247201

### SUMMARY

According to an aspect of the embodiment, a system is capable of transmitting and receiving data through a port, and includes a transceiver unit configured to have a virtual interface for virtually performing data transmission and reception for each second port that is associated with a first port when the first port of a relay device including the first port and a plurality of second ports whose association relationships with the first port can be set arbitrarily is connected to the port, and a control unit configured to determine a virtual interface associated with a second port in which an event was detected, and to perform control in accordance with a content of the event when the relay device detected the event in one of the second ports.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration of a data processing system to which embodiments of the present invention can be applied;

FIG. 2 is a block diagram illustrating a function configuration of a relay device;

FIG. 3 illustrates an example of setting of the relay device;

FIG. 4 explains an example of server-side ports associated with network-side ports;

FIG. 5 illustrates an example of contents of a flow DB;

FIG. 6 illustrates an example of a virtual interface generated on a server connected to the relay device;

FIG. 7 illustrates a configuration of a data processing system to which an embodiment of the present invention has been applied;

FIG. 8 illustrates a configuration of a server according to the present embodiment;

FIG. 9 illustrates an example of a configuration of an adapter included in a server according to the present embodiment;

FIG. 10 is a flowchart of a failure/recovery detection process;

FIG. 11 is a flowchart of a failure/recovery reporting process;

FIG. 12 is a flowchart of a report transmission process;

FIG. 13 illustrates a configuration of a control frame used for reporting a result of event detection by a relay device;

FIG. 14 is a flowchart of a process performed by a link status management unit;

FIG. 15 is a flowchart of a process performed by the link status management unit implemented by an adapter and a CPU; and

FIG. 16 explains an example of a virtual link control command transmitted from the relay device when an event has been detected in a configuration employing an out-band process.

### DESCRIPTION OF EMBODIMENTS

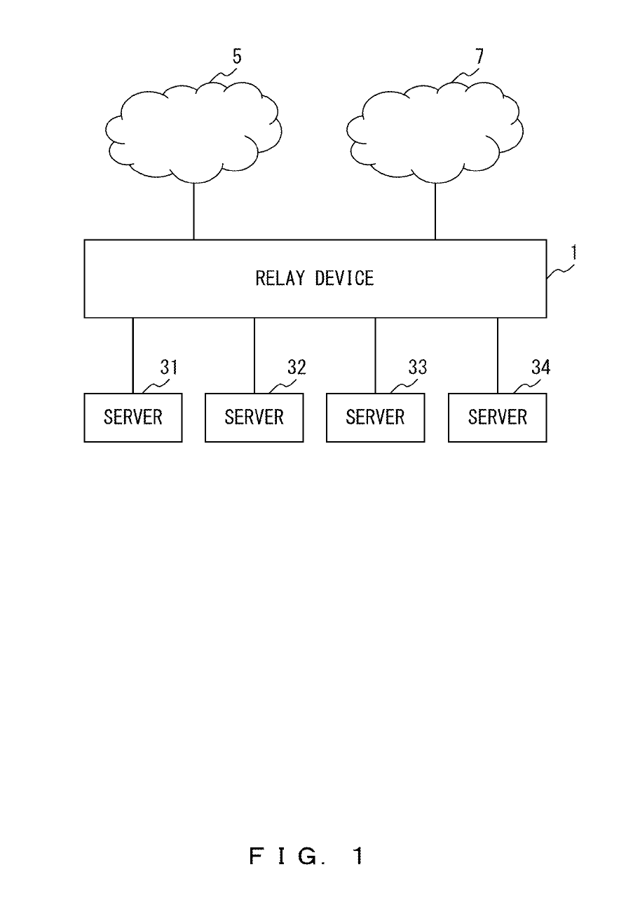

First, detailed explanations will be given to a network system to which embodiments of the present invention can be applied by referring to FIGS. 1 through 5.

FIG. 1 illustrates a configuration of a data processing system to which embodiments of the present invention can be applied. As illustrated in FIG. 1, this data processing system is a computer system in which servers 31 through 34 and networks 5 and 7 are connected to a relay device 1 such as, for example, an Ethernet switch.

The relay device 1 includes a plurality of server-side ports used for connections to the servers, and a plurality of network-side ports used for connections to the networks. Each of the servers 31 through 34 is connected to a different server-side port. Each of the networks 5 and 7 is connected to a different network-side port. In FIG. 1, it is assumed that server-side ports and network-side ports are arranged on the different sides of the relay device 1, respectively.

Note that the networks 5 and 7 are, for example, a LAN (Local Area Network) and a SAN (Storage Area Network). Although four of the servers 31 through 34 are illustrated in FIG. 1, the number of servers that can be connected to the relay device 1 is not particularly limited. Also, the number of networks that can be connected to the relay device 1 is not limited to two.

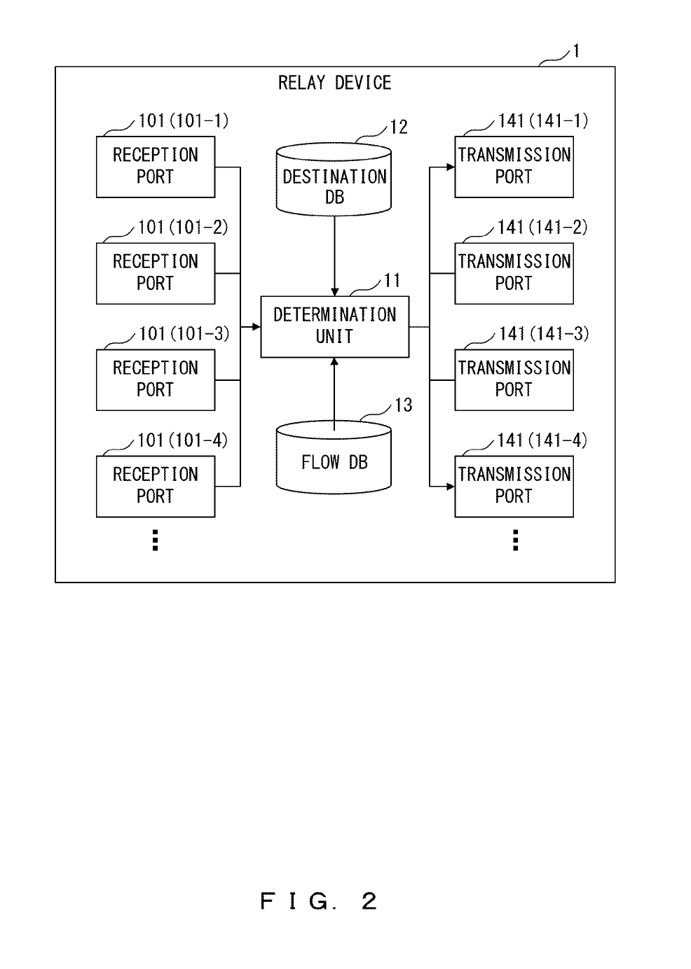

FIG. 2 is a block diagram illustrating a function configuration of the relay device. The relay device 1 includes a plurality of reception ports 101, including reception ports 101-1 through 101-4, a determination unit 11, a first storage unit 12 storing a destination database (DB), a second storage unit 13 storing a flow DB 13, and a plurality of transmission ports 141, including transmission ports 141-1 through 141-4.

When each of the reception ports 101 has received data, it outputs the received data to the determination unit 11. The determination unit 11 refers to the destination DB stored in the storage unit 12 and to the flow DB stored in the second storage unit 13 so as to determine the transmission port 141 as the output destination of the data input from the reception port 101, and outputs the data to the determined transmission port 141. The transmission port 141 outputs the data input from the determination unit 11.

Each of the server-side ports and the network-side ports transmits and receives data. Accordingly, one reception port 101 and one transmission port 141 are assigned to each of them.

When data is transmitted and received through a network, such data is usually treated in a prescribed format such as packet, frame, or the like. Thus, data to be transmitted or received is hereinafter referred to as “frame” for simplicity.

The destination DB is a DB that has stored, in for example each entry (record), destination addresses (usually, MAC (Media Access Control) Accesses), identifiers of VLANs (Virtual LANs), and the identifiers of the transmission ports 141. Thereby, the destination DB can determine the transmission port 141 to output a frame to on the basis of the destination address in that frame. Identifiers of VLANs are, for example, numbers assigned as IDs (Identifiers).

The flow DB is used for relaying frames between server-side ports and network-side ports. In each entry (record), the identification number assigned to a server-side port (server-side port number), a flow identification type (communication type), a flow ID, and the identification number assigned to a network-side port associated with a server-side port (network-side port number) are stored.

The relay device 1 can associate a plurality of network-side ports with one server-side port. Accordingly, in a server-side port with which a plurality of network-side ports are associated, a flow identification type and a flow ID is stored for each of the network-side ports. Thereby, the flow ID can determine a network-side port to output a frame input through the same server-side port on the basis of the flow identification type and the flow ID stored in the frame. This flow DB will be explained later.

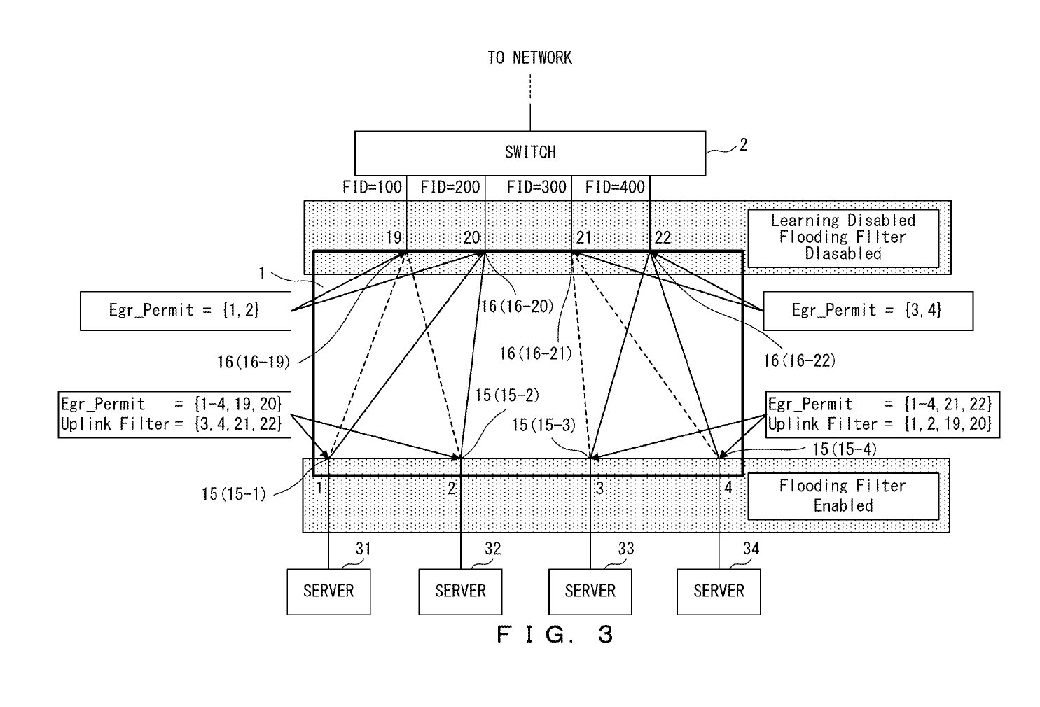

FIG. 3 explains an example of setting of the relay device. In FIG. 3, “1” through “4” are port numbers assigned to the server-side ports 15, and “19” through “22” are port numbers assigned to the network-side ports 16. “15-1” used as a numerical symbol of one of the server-side ports 15 indicates that the port number assigned to that server-side port 15 is “1”. Similarly, “16-19” used as a numerical symbol of one of the network-side ports 16 indicates that the port number assigned to that network-side port 16 is “19”. This manner of denoting constituents is also used in similar cases.

“FID” is an abbreviation for flow ID. For example, “FID=100” indicates that the flow ID is 100. In FIG. 3, “FID=100” represents that a network-side port 16-19 transmits and receives frames with a flow ID 100. This applies to the network-side ports 16-20, 16-21, and 16-22. In the configuration example illustrated in FIG. 3, frames output from the network-side ports 16 are transmitted to an associated network via a switch 2.

Lines (solid lines or dashed lines) connecting server-side ports 15 and the network-side ports 16 represent the association (connection) relationships between the server-side ports 15 and the network-side ports 16. Thereby, a frame input to, for example, the server-side port 15-1 is output through the network-side port 16-19 or 16-20 on the basis of the flow identification type and the flow ID. A frame input to the server-side port 15-2 is output through the network-side port 16-19 or 16-20 on the basis of the flow identification type or the flow ID.

“Egr_Permit={1,2}”, “Egr_Permit={3,4}”, “Egr_Permit={1-4,19,20}”, and “Egr_Permit={1-4,21,22}” in FIG. 3 are related to the setting of the above association relationships. Specifically, these pieces of information are setting information having the following information. The above information is also referred to as “Egr_Permit information” or “Egress Permit information”.

“Egr_Permit={1,2}” given to the network-side ports 16-1 and 16-20 sets that the network-side ports 16-19 and 16-20 only output (pass) frames input to the server-side ports 15-1 or 15-2. Similarly, “Egr_Permit={3,4}” given to the network-side ports 16-21 and 16-22 sets that the network-side ports 16-21 and 16-22 only output (pass) frames input to the server-side port 15-3 or 15-4.

“Egr_Permit={1-4,19,20}” given to the server-side ports 15-1 and 15-2 sets that the server-side ports 15-1 and 15-2 only output a frame input to the server-side ports 15-1 through 15-4, or the network-side ports 16-19 and 16-20. Similarly, “Egr_Permit={1-4,21,22}” given to the server-side ports 15-3 and 15-4 sets that the server-side ports 15-3 and 15-4 only output a frame input to the server-side ports 15-1 through 15-4, or network-side ports 16-21 and 16-22.

Further, “Uplink Filter={3,4,21,22}” is set in the server-side ports 15-1 and 15-2, and “Uplink Filter={1,2,19,20}” is set in the server-side ports 15-1 and 15-2. This setting information is used for preventing flooding. In accordance with this setting information, the server-side ports 15-1 and 15-2 do not output a broadcast frame input to one of the server-side ports 15-3 and 15-4 and network-side ports 16-21 and 16-22, or a unicast frame having an unknown destination. Similarly, the server-side ports 15-3 and 15-4 do not output a broadcast frame input to one of the server-side ports 15-1 and 15-2 and network-side ports 16-19 and 16-20, or a multicast frame.

“Learning Disabled” has been set in the network-side ports 16-19 through 16-22. This setting information specifies that a destination address (e.g., MAC addresses) should not be learned for frames output from the network-side ports 16-19 through 16-22. In accordance with this setting information, destination addresses stored in the above destination DB are possessed by the serves 31 through 34 connected to the server-side ports 15-1 through 15-4, respectively. Thereby, for frames that cannot determine output destination server-side ports 15 from flow identification types and flow IDs from among frames input to one of the network-side port 16-19 through 16-22, output destinations are determined by referring to the destination DB.

“Flooding Filter Enabled” given to the server-side ports 15-1 through 15-4, and “Flooding Filter Disabled” given to the network-side ports 16-19 through 16-22 are also setting information related to flooding. “Flooding Filter Enabled” specifies that unicast frames whose destinations are unknown are filtered and are not output. In accordance with this, the server-side ports 15-1 through 15-4 do not output unicast frames whose destinations are unknown. “Flooding Filter Disabled” specifies that unicast frames whose destinations are unknown are output without being filtered. In accordance with this, the network-side ports 16-19 through 16-22 output unicast frames whose destinations are unknown.

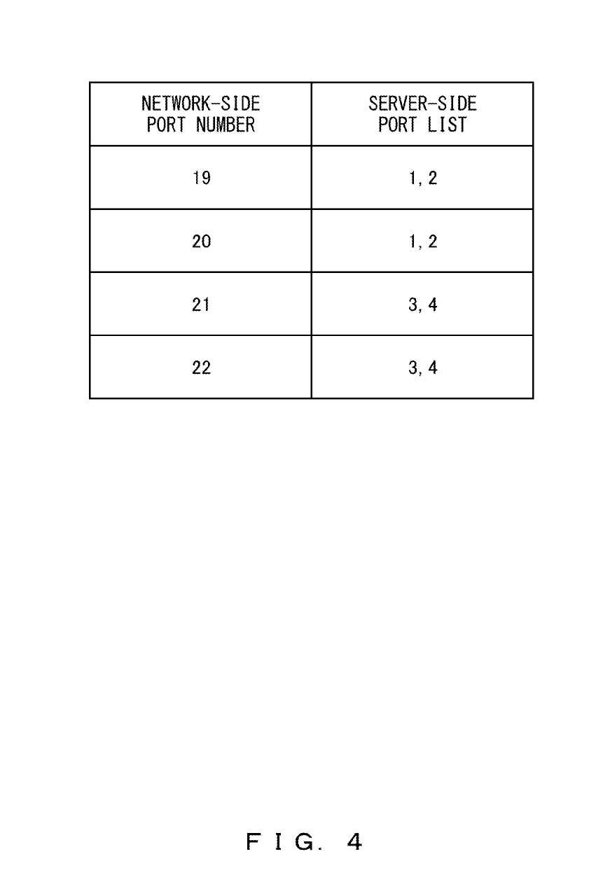

FIG. 4 explains an example of server-side ports associated with network-side ports. In FIG. 4, for each network-side port number, the server-side ports 15 associated with the network-side ports 16 having the network-side port number is represented. As illustrated in FIG. 4, two of the server-side ports 15 are associated with each network-side port 16 when the setting as illustrated in FIG. 3 is adopted.

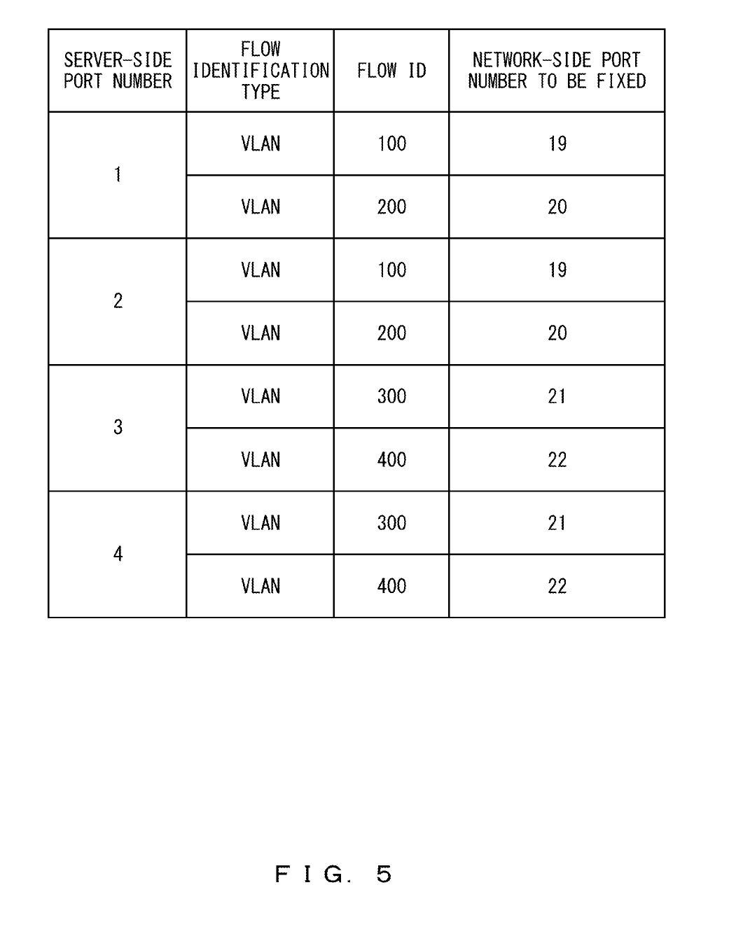

FIG. 5 illustrates an example of contents of the flow DB. FIG. 5 illustrates a case where the setting as illustrated in FIG. 3 is adopted for the relay device 1. As described above, each entry (record) of the flow DB stores the server-side port number, a flow identification type (communication type), a flow ID, and the network-side port number (“network-side port number to be fixed” in FIG. 5). Each server-side port 15 is associated with two of the network-side ports 16. Accordingly, two groups each including a flow identification type, a flow ID, and a network-side port number are written in each entry.

“VLAN” in FIG. 5 is written as information representing a flow identification type. As a flow ID, a VLAN ID may be used. A flow ID is used only for identifying transmitted and received frames, and accordingly, it can be data representing a priority, a priority group, TOS (Type Of Service), a communication protocol, a transmission source address (for example, a MAC address or IP (Internet Protocol) address), or the like.

The network-side ports 16 that are output destinations of frames input to the server-side ports 15 can be determined from flow identification types and flow IDs. However, the server-side ports 15 that are output destinations of frames input to the network-side ports 16 cannot always be determined from flow identification types and flow IDs. When they cannot be determined, they are determined from destination DB.

As described above, the relay device 1 can associate the plurality of network-side ports 16 with one server-side port 15. A server connected to the server-side port 15 that has been associated with the plurality of network-side ports 16 has to generate a virtual interface so that frames can be transmitted and received through arbitrary network-side ports 16. A virtual interface is also referred to as vNIC (virtual Network Interface Card), vHBA (virtual Host Bus Adapter), or the like, depending upon the usage, or the like.

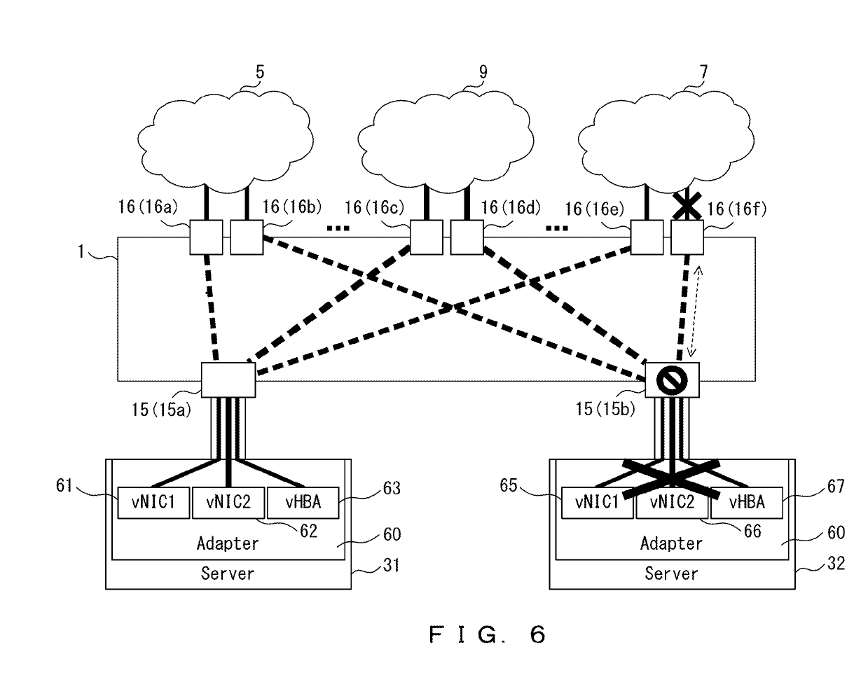

FIG. 6 explains an example of a virtual interface generated on a server connected to a relay device. In FIG. 6, the network-side ports 16a, 16c and 16e are associated with the server-side port 15a while the network-side ports 16b, 16d and 16f are associated with the server-side port 15b in the relay device 1. Accordingly, two vNICs 61 and 62 and one vHBA 63 are generated as virtual interfaces on an adapter 60 included in the server 31 connected to the server-side port 15a. Similarly, two vNICs 65 and 66 and one vHBA 67 are generated as virtual interfaces on the adapter 60 included in a server 32 connected to the server-side port 15b.

The relay device 1 has a function of detecting as an event a failure that occurred in a network connected to each of the network-side ports 16, and reporting that fact when it has detected a failure. That function reports the detection by, for example, disconnecting (turning off) the server-side port 15 associated with the network-side port that is connected to the network in which a failure has been detected. By this function, the relay device 1 can make the server 31 or 32 recognize a failure that has occurred for each of the network-side ports 16.

Reports to the servers 31 and 32 are received by the adapters 60. When the adapters 60 have stopped transmission and reception of frames in response to those reports, all virtual interfaces generated on the adapter 60 of the servers 31 and 32 are stopped.

FIG. 6 illustrates a case where a failure that occurred in a network 7 was detected by the relay device 1 in the network-side port 16f, and the detection result was reported from the server-side port 15b to the server 32. Specific explanations will be given to the above failure by using this case as an example.

In this case, two vNICs 65 and 66 and one vHBA 67 have been generated on the adapter 60 included in the server 32. Thereby, the vNICs 65 and 66 and the vHBA 67 implement transmission and reception of frames through the network-side ports 16b, 16d, or 16f that are associated with the server-side port 15b.

It is not always true that in both of the networks 5 and 9 respectively connected to the network-side ports 16b and 16d failure occurs when a failure that occurred in the network 7 has prevented the transmission and reception of frames through the network-side port 16. Accordingly, when all virtual interfaces are halted by a failure occurring in the network 7 connected to the network-side port 16, the transmission and reception of frames through the network not involving a failure between the networks 5 and 9 are also prevented. Halting the transmission and reception of frames through a network not involving failures leads to drastic deterioration of the servers' processing efficiency. Thus, when a server is connected to the above relay device 1, the network-side port 16 associated with the server-side port 15 to which that server is connected has to be taken into consideration in order to make an appropriate response to a failure (event) that has occurred in a network.

In view of the above necessity, embodiments of the present invention realize appropriate responses to results of detection, performed by the relay device 1, of events that occurred in a network when the apparatus of the present invention is connected to the relay device 1 such as is described above. Hereinbelow, detailed explanations will be given to embodiments of the present invention by referring to drawings.

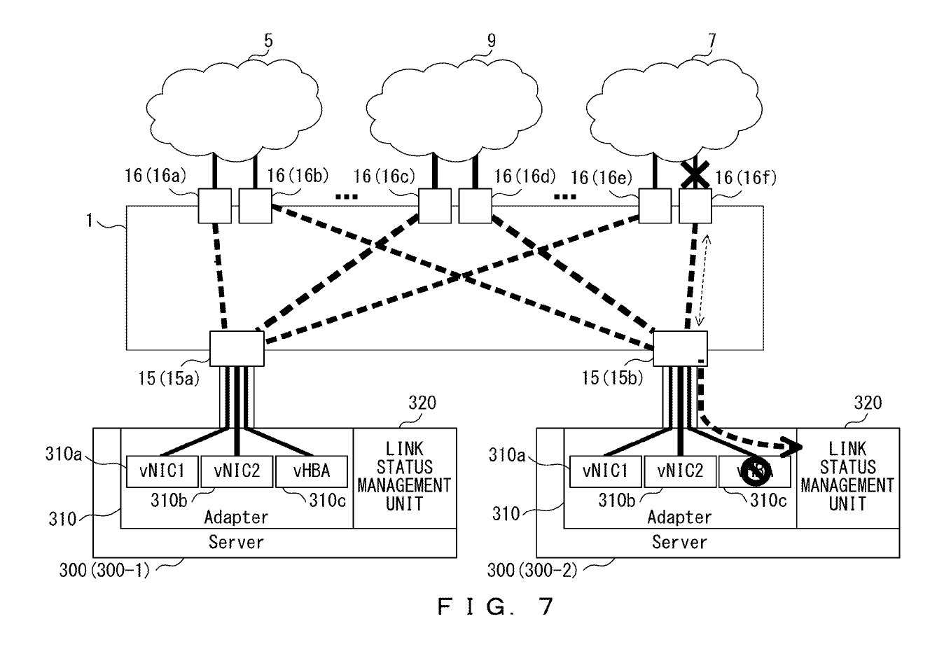

FIG. 7 illustrates a configuration of a data processing system to which an embodiment of the present invention is applied. As illustrated in FIG. 7, this data processing system is a computer system in which two servers 300 (300-1 and 300-2) and the networks 5, 7, and 9 are connected to the relay device 1. The present embodiment is implemented as the servers 300 (data processing apparatuses) that are connected to the server-side ports 15a and 15b of the relay device 1, respectively.

The relay device 1 illustrated in FIG. 7 may be the same as the relay device 1 explained by referring to FIGS. 1 through 6. The networks 5, 7, and 9 may also be the same as those illustrated in FIG. 1 or 6. Accordingly, they are denoted by the same numerals.

Each of the servers 300 according to the present embodiment includes an adapter 310 connected the server-side port 15 of the relay device 1, and a link status management unit 320.

The adapter 310 may generate a virtual interface for each of the network-side ports 16 associated with the connected server-side ports 15. Similarly to the example illustrated in FIG. 6, the network-side ports 16a, 16c, and 16e are associated with the server-side ports 15a while the network-side ports 16b, 16d, and 16f are associated with the server-side ports 15b in the relay device 1. Accordingly, two vNICs, i.e., vNICs 310a and 310b, and a vHAB 300c are generated as a virtual interface on the adapter 310 included in each of the servers 300-1 and 300-2 that are connected to the server-side ports 15a and 15b.

The link status management unit 320 separately operates (turns on) and halts (turns off) virtual interfaces generated on the adapter 310 in response to results of detection of events, performed by the relay device 1 for each of the network-side ports 16, that have occurred in a network. Thereby, the link status management unit 320 makes each server 300 remain in a state that permits the server 300 to communicate with networks not involving failures even when a failure has occurred in one of networks that are able to perform communication. Accordingly, each server 300 can continue communications with networks not involving failures even when a failure has occurred in one of the networks. Therefore, each of the servers 300 can avoid or suppress the deterioration of processing efficiencies caused by halting communications with networks that are capable of performing communications.

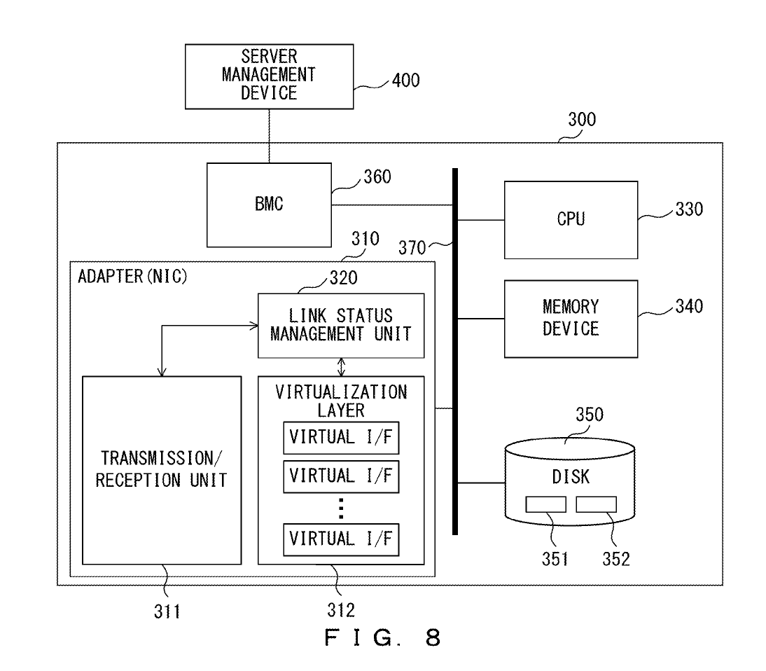

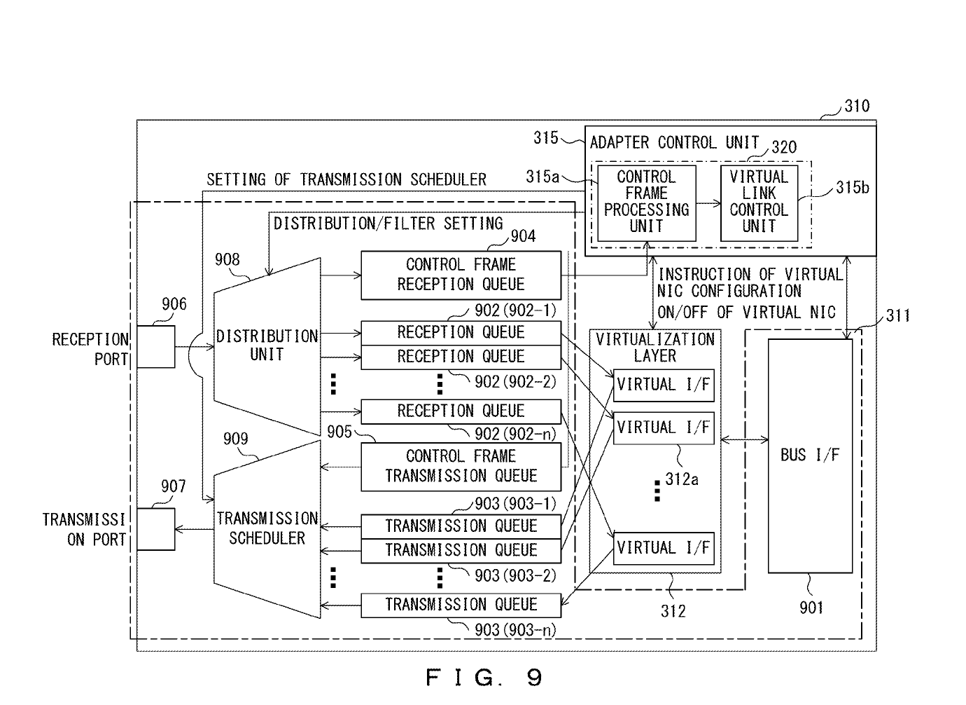

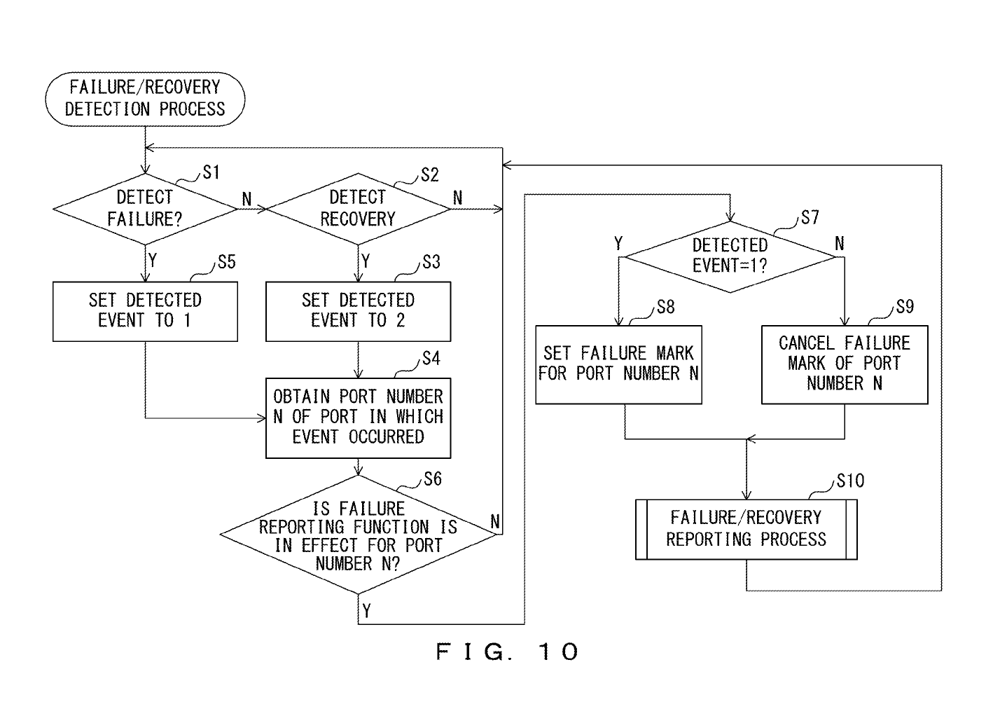

FIG. 8 illustrates a configuration of a server according to the present embodiment. FIG. 9 illustrates an example of a configuration of an adapter included in a server according to the present embodiment. Detailed explanations will be given for operations of the relay device 1 when it responds to events occurring in networks by referring to FIGS. 10 through 13 before giving explanations of a server according to the present embodiment based on FIGS. 8 and 9. For simplicity, the only events assumed in this example are a failure and recovery from a failure.

FIG. 10 is a flowchart of a failure/recovery detection process. This failure/recovery detection process is executed for detecting an event (failure or recovery from the failure) that has occurred in a network connected to one of the network-side ports 16. In the configuration of the relay device 1 illustrated in FIG. 2, this failure/recovery detection process can be executed by the determination unit 11. First, this failure/recovery detection process will be explained in detail by referring to FIG. 10.

Failures in a network can be detected by monitoring frames that are transmitted and received periodically (these frames correspond to, for example, “hello packets”, and are referred to as “observation frames” hereinafter). A failure can be determined to have occurred when an observation frame is not received within a prescribed time. When the relay device 1 is connected directly to a node in a network through a cable or the like, the occurrence of a link failure (link down) between the relay device 1 and that node can be regarded as a failure in the network. Recovery from a failure can be detected by the restarting of reception of observation frames, linking up, or the like.

First, the determination unit 11 determines whether or not a new failure has been detected in one of the network-side ports 16 (networks) (S1). When a prescribed time has elapsed without the reception of observation frames or when a link down has occurred in one of the reception ports 101 assigned to the network-side ports 16 in which no failures have been detected, the determination result is YES in S1. In such a case, the determination unit 11 sets “detected event”, which is a variable, to 1, or substitutes “1” into “detected event” (S5), and the process proceeds to S4. When a prescribed time has not elapsed without the reception of observation frames and no link down has occurred in all of the reception ports 101 assigned to the network-side ports 16, the determination result is NO in S1, and the process proceeds to S2.

The above detected event is used for holding information representing whether a result of event detection (i.e., a detected event) is failure or recovery. A failure mark, which is a variable, is used for holding a result of detecting an event for each of the network-side ports 16. A failure mark will be described later. By using this failure mark, the type of an event detected in each network-side port 16 can be determined. In the network-side port 16 in which a failure has been detected as an event, a failure mark is set by, for example, substituting “1” into the value of the failure mark. In the network-side port 16 in which recovery has been detected as an event, a failure mark is cancelled by, for example, substituting “0” into the value of the failure mark.

Note that “detection of failure”, “occurrence of failure”, or the like is intended to mean, in a broader sense, a state between detection of a failure or occurrence of a failure and detection of the recovery or a time point immediately before the recovery. Similarly, “detection of recovery from a failure”, “recovery from failure”, or the like is intended to mean, in a broader sense, a state between detection of recovery from a failure or recovery from a failure and detection of the next failure or occurrence of the next failure.

In S2, the determination unit 11 determines whether or not recovery from a failure has been detected in one of the network-side ports 16 (networks) in which a failure had been detected. When one of the reception ports 101 that are assigned to the network-side ports 16 in which a failure was detected has received an observation frame or when a linkup has occurred in one of them, the determination result is YES in S2. In such a case, the determination unit 11 sets the detected event to “2”, or substitutes “2” into the detected event (S3), and the process proceeds to S4. When none of the reception ports 101 that are assigned to the network-side ports 16 in which a failure had been detected has received observation frames and no link up has occurred, the determination result is NO in S2, and process returns to S1. Thereby, the determination unit 11 continues detection of failures and recovery from failures.

In S4, the determination unit 11 obtains port number N of the network-side port 16 in which a failure or recovery from a failure was detected as an event. Next, the determination unit 11 determines whether or not the failure reporting function in the network-side port 16 having port number N (denoted by “PORT N” in FIG. 10), i.e., the mode of reporting a detected event, is in effect. When the failure reporting function is in effect, the determination result is YES in S6, and the process proceeds to S7. When the failure reporting function is not in effect, the determination result is NO in S6, and the process returns to S1. The setting of the failure reporting function is performed in accordance with setting information (not illustrated in FIG. 3).

In S7, the determination unit 11 determines whether or not the value of the detected event is “1”. When the value of the detected event is “1”, the determination result is YES in S7, and the determination unit 11 sets the failure mark for the network-side port 16 having port number N (S8), and the process proceeds to S10. When the value of the detected event is “2”, the determination result is NO in S7, and the determination unit 11 cancels the failure mark of the network-side port 16 having port number N (S9), and the process proceeds to S10.

In S10, the determination unit 11 executes a failure/recovery reporting process in order to report the detected event through the server-side port 15 associated with the network-side port 16 having the port number N. After the execution, the process returns to S1.

By performing the processes described above, the relay device 1 detects an event occurring in on one of the network-side ports 16, and reports the detected result through each of the server-side ports 15 associated with the network-side port 16 in which the event was detected. Each of the servers 300 according to the present embodiment performs an in-band process in response to the report. Specifically, the relay device 1 processes the reports in the adapter 310, and controls a virtual interface 312a. Accordingly, the link status management unit 320 is included in the adapter 310. Thus, the data transmission/reception apparatus according to the present embodiment is implemented as the adapter 310.

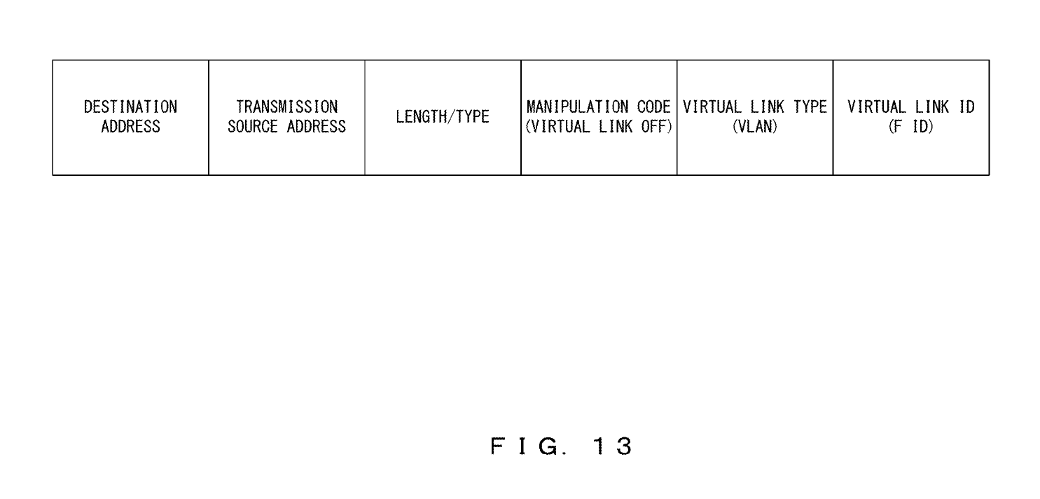

Explanations will now be given for a configuration of a control frame used for reporting an event detection result by referring to FIG. 13.

As illustrated in FIG. 13, a control frame includes a destination address, a transmission source address, data representing the length or type of the control frame itself, a manipulation code, data representing the virtual link type, a virtual link ID, and the like.

A manipulation code represents content of operations that are to be made in the destination of a control frame. “VIRTUAL LINK OFF” in FIG. 13 requests the adapter 310 that receives this control frame to halt the virtual interface 312a. Accordingly, the manipulation code is data representing the type of a detected event. The manipulation code requesting operations of the adapter 310 is “VIRTUAL LINK ON”.

A virtual link type is data of the same sort as a flow identification type illustrated in FIG. 4. A flow identification type is stored in a control frame as data of a virtual link type. A flow ID illustrated in FIG. 4 is stored as data of a virtual link ID. Accordingly, a virtual link type and a virtual link ID can be extracted by referring to a flow DB by using port number N.

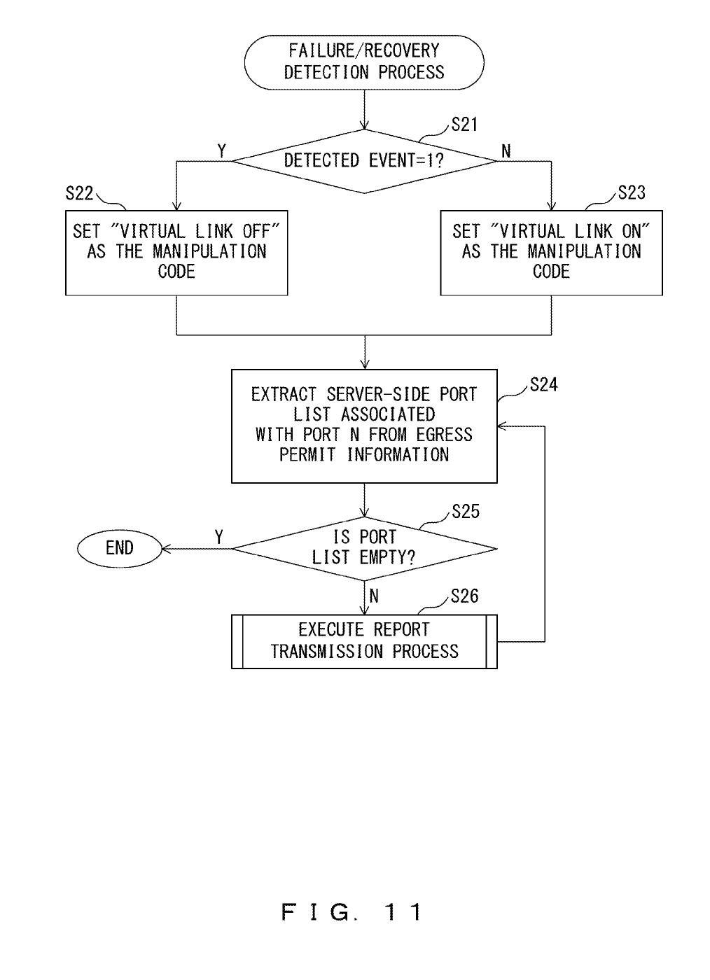

FIG. 11 is a flowchart of the failure/recovery reporting process. Explanations will be given for the failure/recovery reporting process executed in S10 by referring to FIG. 11.

First, the determination unit 11 determines whether or not the value of a detected event is “1” (S21). When the value of the detected event is “1”, the determination result is YES in S21, and the determination unit 11 sets “VIRTUAL LINK OFF” as the manipulation code stored in the control frame (S22), and the process proceeds to S24. When the value of the detected event is “2”, the determination result is NO in S21, and the determination unit 11 sets “VIRTUAL LINK ON” as the manipulation code stored in the control frame (S23), and the process proceeds to S24.

In S24, the determination unit 11 extracts port numbers of the server-side ports 15 associated with the network-side port 16 having port number N, and obtains (generates) a server-side port list, which includes extracted port numbers in a listed manner.

The above server-side port list is, in an actual configuration, a storage region that has stored extracted port numbers. The transmission of control frames illustrated in FIG. 13 is performed for each of the server-side ports 15 stored in the server-side port list while deleting the port numbers of the server-side ports 15.

Next, the determination unit 11 determines whether or not the server-side port list is empty, i.e., whether the list has no port numbers stored in it. When the server-side port list has no port numbers, the detection result is YES in S25, and the failure/recovery reporting process is terminated. When the server-side port list has a port number, the denomination in S25 is NO, and the process proceeds to S26.

In S26, the determination unit 11 obtains a port number from the server-side port list, and executes a report transmission process, which generates and transmits a control frame to be transmitted through the server-side port 15 to which the extracted port number is assigned. After the execution of this process, the process returns to S25. Generation and transmission of control frames are performed for each of the server-side ports 15.

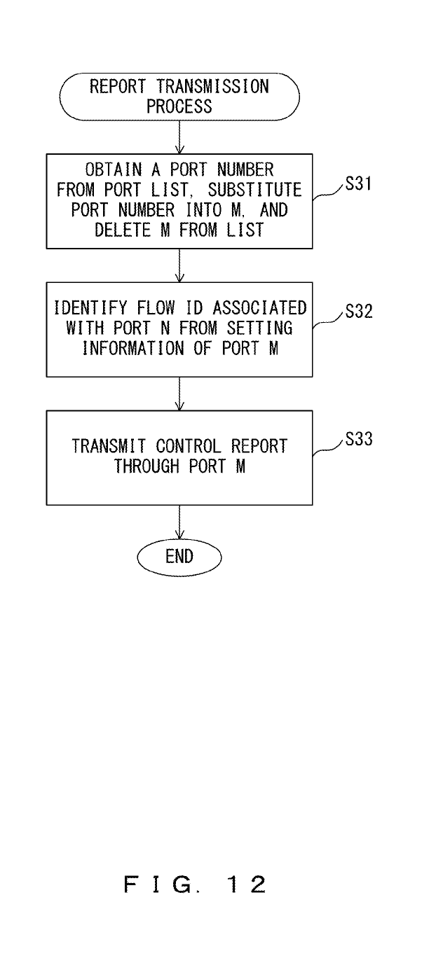

FIG. 12 is a flowchart of the report transmission process. Detailed explanations will be given for the report transmission process as an operation performed by the relay device 1 in order to respond to events occurring in networks, by referring to FIG. 12.

First, the determination unit 11 obtains a port number from the server-side port list, substitutes the obtained port number into a variable M, and deletes the obtained port number from the server-side port list (S31). Next, the determination unit 11 refers to the flow DB in order to identify the flow identification type and the flow ID (S32) set between the server-side port 15 having the value of the variable M as its port number (“PORT M” in FIG. 12) and the network-side port 16 having the port number N.

Next, the determination unit 11 obtains, as a destination address, the address of the server 300 connected to the server-side port 15 that has the value of the variable M as the port number, and generates a control frame (“CONTROL REPORT” in FIG. 12), and transmits the frame through the server-side port 15 (S33). Thereafter, the report transmission process is terminated.

The generated frame includes the obtained destination address, the flow identification type (virtual link type) and the flow ID (virtual link ID) identified in S32 and the manipulation code set in S22 or S23 in FIG. 11. This control frame is transmitted through each of the server-side ports 15 associated with the network-side port 16 in which an event was detected.

It is assumed that the servers 300 according to the present embodiment receive control frames from the relay device 1. Hereinbelow, explanations will be given for the servers 300 according to the present embodiment.

As illustrated in FIG. 8, the server 300 according to the present embodiment includes a CPU (Central Processing Unit) 330, a memory device 340, a disk device 350, a BMC (Baseboard Management Controller) 360, and a bus 370 in addition to the adapter 310, and the link status management unit 320 included in the adapter 310. The bus 370 connects the adapter 310, the CPU 330, the memory device 340, the disk device 350, and the BMC 360 to each other.

The disk device 350 stores various programs executed by the CPU 330, various types of data, and the like. Examples of various programs include various application programs, an OS (Operating System) 351, and various device drivers (abbreviated to “driver” hereinafter). An example of various drivers is a driver 352 for the adapter 310.

In FIG. 8, the driver 352 and the OS 351 are illustrated separately. This is because the driver 352 does not always have to be included in the OS 351. Accordingly, the driver 352 may be installed newly into the server 300 that has already started its operation.

The BMC 360 is a management device that turns on/off the power of the servers 300, detects failures, and performs other functions. This BMC 360 is connected to a server management device 400 through a dedicated network, provided separately from the network 5, 7, or 9. The server management device 400 manages an information processing apparatus including the respective servers 300 connected to the relay device 1. The server management device 400 may perform various kinds of setting of the relay device 1.

Instead of the BMC 360, each server 300 may include an iRMC (integrated Remote Management Controller), which is a BMC further provided with an extension function. A normal NIC may also be included.

The adapter 310 includes a transmission/reception unit 311 and a virtualization layer unit 312 in addition to the link status management unit 320 that has been mounted. The transmission/reception unit 311 is a constituent that enables transmission and reception of data between the bus 370 of each server 300 and the relay device 1 to which the servers 300 are connected. The virtualization layer unit 312 is a constituent that virtualizes the adapter 310, and inputs and outputs data between itself and the transmission/reception unit 311. In the virtualization layer unit 312, a virtual interface (“VIRTUAL I/F” in FIG. 8) 312a is generated as a constituent that transmits and receives data virtually between itself and the transmission/reception unit 311. By generating the virtual interface 312a, the vNICs 310a and 310b, and a vHBA 310c illustrated in FIG. 7, are implemented in the adapter 310. In other words, the vNICs 310a and 310b and the vHBA 310c illustrated in FIG. 7 are implemented by the virtual interface 312a configured on the virtualization layer unit 312.

The adapter 310 includes an adapter control unit 315 as illustrated in FIG. 9. The adapter control unit 315 performs overall control of the adapter 310. The virtualization layer unit 312 configures the virtual interface 312a in accordance with an instruction from the server-side ports 15. The virtualization layer unit 312 also turns on (operate) and turns off (halt) the configured virtual interface 312a in accordance with an instruction from the adapter control unit 315.

The transmission/reception unit 311 includes a bus interface 901 (interfaces in FIG. 9 are denoted by “I/F”), a plurality of reception queues (902-1 through 902-n), a plurality of transmission queues 903 (903-1 through 903-n), a control frame reception queue 904, a control frame transmission queue 905, a reception port 906, a transmission port 907, a distribution unit 908, and a transmission scheduler 909.

The bus interface 901 inputs and outputs data to and from the CPU 330 through the bus 370. The bus interface 901 outputs to the bus 370 data input from the virtualization layer unit 312, and outputs to the virtualization layer unit 312 or the adapter control unit 315 data input from through the bus 370. Data input to the virtualization layer unit 312 is forwarded to the associated virtual interface 312a. The CPU 330 inputs and outputs data to and from the adapter 310 through the bus 370 by using the OS 351 and the driver 352.

Data output in a form of frame from the virtual interface 312a on the virtualization layer unit 312 is stored in the associated transmission queue 903. The transmission scheduler 909 selects a frame stored in one of the control frame transmission queues 905 and 903 in accordance with the setting performed by the adapter control unit 315, and outputs the selected frame to the transmission port 907. As a result of this, a frame is transmitted to the relay device 1 through the transmission port 907 of the server 300. The adapter control unit 315 generates a control frame to be stored in the control frame transmission queue 905.

The reception port 906 receives a frame transmitted from the relay device 1, and outputs the received frame to the distribution unit 908. The adapter control unit 315 sets the associated reception queue 902 (distribution setting) for, for example, each destination address or flow ID. Thereby, the distribution unit 908 refers to the destination address or the flow ID in the frame received from the reception port 906 so as to store the received frame in the associated reception queue 902. A frame stored in the reception queue 902 is output to the associated virtual interface 312a on the virtualization layer unit 312.

The distribution unit 908 determines a frame that is not to be output to the reception queue 902 in accordance with the setting (filter setting) performed by the adapter control unit 315, and discards the determined frame. By this filtering function, only frames that are to be stored are actually stored in the respective reception queues 902.

When the reception port 906 has received a control frame as illustrated in FIG. 13, the received control frame is stored in the control frame reception queue 904 by the distribution unit 908. The control frame stored in that control frame reception queue 904 is input to the adapter control unit 315 to be processed by it.

The adapter control unit 315 includes a control frame processing unit 315a, and a virtual link control unit 315b.

The control frame processing unit 315a processes a control frame received through the reception port 906, and outputs necessary information to, for example, the virtual link control unit 315b. Also, the control frame processing unit 315a generates a control frame to be transmitted, and stores the generated control frame in the control frame transmission queue 905 in accordance with an instruction from the CPU 330. When a control frame as illustrated in FIG. 13 is to be processed, the control frame processing unit 315a extracts the operation code, the virtual link type (flow identification type), and the virtual link ID (flow ID) from, for example, a control frame, and outputs them to the virtual link control unit 315b.

The virtual link control unit 315b controls the virtualization layer unit 312. As described above, when the reception port 906 has received a control frame as illustrated in FIG. 13, the virtual link control unit 315b inputs an operation code, a virtual link type (flow identification type), and a virtual link ID (flow ID) through the control frame processing unit 315a. In such a case, the virtual link control unit 315b determines the virtual interface 312a as the target of the control on the basis of the virtual link type and the virtual link ID, and controls the determined virtual interface 312a in accordance with the operation code. Thereby, each of the virtual interfaces 312a on the adapter 310 is turned on and off separately in response to reception of control frames as illustrated in FIG. 13. As a result of this, the virtual interface 312a on the adapter 310 associated with the network-side port 16 in which the relay device 1 has detected an event (failure or recovery) is turned on/off separately in accordance with the network-side port 16 and the type of the event. Accordingly, the link status management unit 320 is implemented by using the control frame processing unit 315a and the virtual link control unit 315b included in the adapter control unit 315.

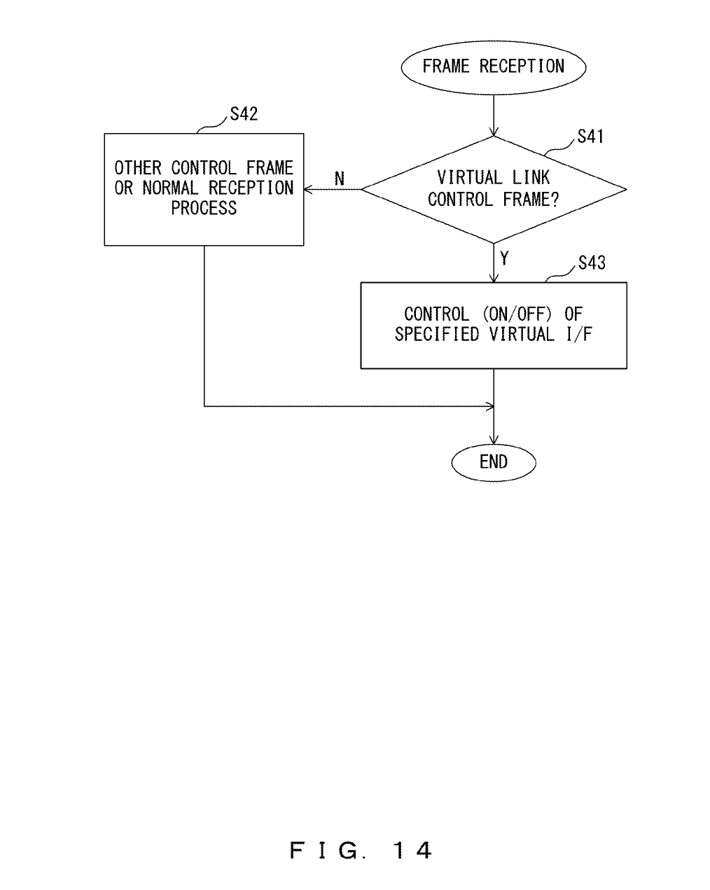

FIG. 14 is a flowchart of a process performed by the link status management unit. FIG. 14 represents the flow of the process (operation) executed when a received control frame is processed by the link status management unit 320 implemented by using the control frame processing unit 315a and the virtual link control unit 315b. Next, operations of the link status management unit 320 implemented by using the control frame processing unit 315a and the virtual link control unit 315b will be explained in detail by referring to FIG. 14.

First, the control frame processing unit 315a determines whether or not a control frame extracted from the control frame reception queue 904 is a control frame (“VIRTUAL LINK CONTROL FRAME” in FIG. 14; this name is used hereinafter) related to the turning on/off of the virtual interface 312a as illustrated in FIG. 14 (S41). When the control frame is a virtual link control frame, the determination result is YES in S41, and the process proceeds to S43. When the control frame is not a virtual link control frame, the determination result is NO in S41, and the process proceeds to S42.

In S42, the control frame processing unit 315a performs a process in accordance with the extracted control frame. When the control frame requests that the control be performed in the adapter 310, the control frame processing unit 315a performs the control as requested by the control frame, and outputs necessary information to the CPU 330 via the bus interface 901. When the control frame does not request that the control be performed in the adapter 310, the control frame processing unit 315a performs a normal reception process via the bus interface 901 in order to output the content of the control frame to the CPU 330. After this process is performed in S42, this series of processes is terminated.

In S43, the control frame processing unit 315a extracts the operation code, the virtual link type (flow identification type), and the virtual link ID (flow ID), and outputs them to the virtual link control unit 315b. The virtual link control unit 315b determines a virtual interface as a control target on the basis of the virtual link type and the virtual link ID, and turns on/off the determined virtual interface in accordance with the operation code (S43). After the process is performed in S43, this series of processes is terminated.

The control performed by the adapter 310, in which the virtual interface 312a is turned on/off as described above, is performed in the adapter 310 itself by an in-band process based on an assumption that the relay device 1 transmits virtual link control frames through the server-side ports 15. However, the in-band process may be performed in a different form. Specifically, it is also possible to employ, for example, a configuration in which the adapter 310 transfers a virtual link control frame as it is or transfers information extracted from a virtual link control frame to the CPU 330 (driver 352) so that the adapter 310 turns on/off the virtual interface 312a in accordance with instructions from the CPU 330. In such a case, the link status management unit 320 is implemented by using the adapter 310 (or the adapter control unit 315 of the adapter 310) and the CPU 330.

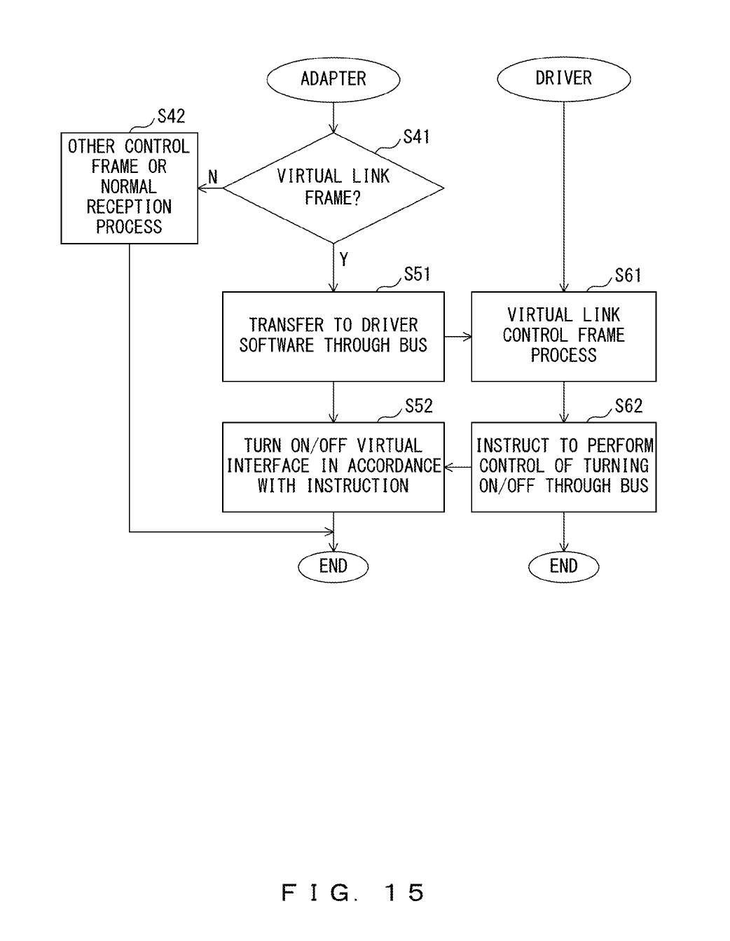

FIG. 15 is a flowchart of a process performed by a link status management unit implemented by the adapter and the CPU. FIG. 15 illustrates two flowcharts separately so that the operations (processes) by the adapter 310 and the CPU 330 are explained clearly. The driver 352 is assumed to be a program that implements processes by the CPU 330, and that process is titled “DRIVER” in FIG. 15. The same or almost the same processes as in FIG. 14 are denoted by the same numerical symbols. Accordingly, explanations will be focused on portions different from the processes in FIG. 14.

When the determination result in S41 is YES, the control frame processing unit 315a of the adapter 310 makes the process proceed to S51, and transfers, for example, a virtual link control frame to the CPU 330 as it is. That transfer is performed via the bus interface 901 and the bus 370.

The CPU 330 (or the driver 352 implemented by the CPU 330) performs the processes for a virtual link frame transferred from the adapter 310 (S61). Next, the CPU 330 gives a control instruction to make the adapter 310 turn on/off the virtual interface 312a (S62). When this control instruction is given, the series of processes on the side of the CPU 330 is terminated.

In the control instruction, the virtual interface 312a to be turned on/off can be specified on the basis of the extracted virtual link type (flow identification type) and virtual link ID (flow ID). The turning on/off of the specified virtual interface 312a can be based on instructions from a control command corresponding to the operation code extracted from the virtual link control frame.

After transferring a virtual link control frame to the CPU 330, the adapter 310 waits until a control instruction is input from the CPU 330. When a control instruction is input, the adapter 310 turns on/off the virtual interface 312a in accordance with the input control instruction (S52). After the turning on/off is performed, the series of processes on the side of the adapter 310 is terminated.

When an in-band process is assumed, a variation example as described above may also be employed in an individual turning on/off of the virtual interface 312a generated on the adapter 310. Other variation examples may also be employed. Accordingly, various modifications may be made for a control method that employs an in-band process.

When the server management device 400 as illustrated in FIG. 8 exists, each of the servers 300 can recognize events detected in the respective network-side ports 16 by the determination unit 11 via the server management device 400. Accordingly, when an external device such as the server management device 400 exists, an out-band process may also be employed for controlling the virtual interface 312a configured on the adapter 310 without making the relay device 1 transmit a virtual link control frame through the server-side port 15. An out-band process may also be employed in a system environment in which the relay device 1 is connected to each of the servers 300 through a dedicated network (or a bus).

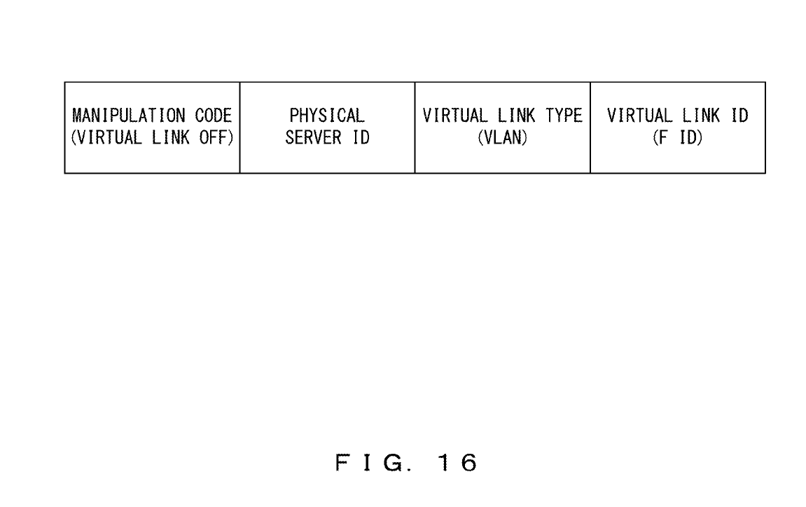

When the server management device 400 is assumed to exist, the relay device 1 transmits, for example, a control command (virtual link control command) as illustrated in FIG. 16 to the server management device 400. The physical server ID stored in the control command is identification information uniquely representing the server 300 that is connected to the server-side port 15 associated with the port number obtained from the server-side port list in S31 illustrated in FIG. 12, i.e., the server 300 connected to the server-side port 15 having that port number. When an out-band process is employed, the relay device 1 transmits a virtual link control command as illustrated in FIG. 16 to the server management device 400 instead of transmitting a virtual link control frame in S33 illustrated in FIG. 12. The server management device 400 transfers a virtual link control command received from the relay device 1 to the server 300 determined by the physical server ID.

Data from the server management device 400 is received by the BMC 360 of the server 300. A received virtual link command control command may be directly transferred from the BMC 360 to the adapter 310 so that the command is processed by the adapter 310 on the side of the server 300. It is also possible to transfer a received virtual link control command from the BMC 360 to the CPU 330 so that the control command is processed by the CPU 330 and the CPU 330 controls the adapter 310. Accordingly, various control methods may be employed even when an out-band process is employed.

When an in-band process is employed, the server 300 receives a virtual link control frame directly from the server-side port 15 of the relay device 1. Accordingly, by contrast to a case of employing an out-band process, it is not necessary to use a different network or the like to be connected directly or indirectly to the relay device 1. Therefore, an in-band process is advantageous in that it can be employed regardless of the type of system environment. In other words, an in-band process can be applied to more various types of data processing systems than an out-band process.

However, with an in-band process, it is necessary to include the adapter 310 in the server 300 in order to support an in-band process to be executed. By contrast, it is not necessary to include an adapter having new functions in a server with an out-band process. The driver 352 (or the OS 351) for supporting an out-band processes implemented by a server for this purpose.

Accordingly, it is relatively easy to apply an out-band process to an existing server than an in-band process. Also, it is not necessary to perform replacement etc. of an adapter, reducing hardware cost. These points are advantages for an out-band process compared with an in-band process.

Accordingly, it is desirable to determine whether to employ an in-band process or an out-band process on the basis of the system environment, urgency, cost, and the like. It is also possible to employ a configuration in which the in-band process and the out-band process are both supported so that one of them can be selected in accordance with the setting or automatically.

Note that while the present invention is applied to a server as a data processing apparatus, the present invention may also be applied to a data processing apparatus of a type different from a server. The present invention works as long as a data processing apparatus is a data processing apparatus to be connected to the server-side ports 15 of the relay device 1.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing apparatus that transmits and receives data through a port, the data processing apparatus comprising:
a transceiver unit configured to have a virtual interface for virtually performing data transmission and reception for each second port that is associated with a first port when the first port of a relay device including the first port and a plurality of second ports whose association relationships with the first port can be set arbitrarily is connected to the port; and
a control unit configured to determine a virtual interface associated with a second port in which an event was detected, and to perform control in accordance with content of the event when the relay device detected the event in one of the second ports.

2. The data processing apparatus according to claim 1, wherein:
when the relay device is to transmit control information that includes identification information representing a second port in which the event was detected through a first port associated with the second port, the control unit determines and controls the associated virtual interface on the basis of control information received through the port.

3. The data processing apparatus according to claim 1, further comprising:
a different transceiver unit configured to receive control information including identification information representing a second port in which the event was detected when the relay device is to transmit the control information through a port that is not the first port associated with the second port,
wherein the control unit determines and controls the associated virtual interface on the basis of the control information received by the different transceiver unit.

4. The data processing apparatus according to claim 1, wherein the event is a failure and recovery from the failure that occurred in a network connected to the second ports.

5. A data transceiver apparatus that transmits and receives data through a port, the apparatus comprising:
a transceiver unit capable of configuring a virtual interface for virtually performing data transmission and reception for each second port that is associated with a first port when the first port of a relay device including the first port and a plurality of second ports whose association relationships with the first port can be set arbitrarily is connected to the port; and
a control unit configured to determine a virtual interface associated with a second port in which an event was detected, and to perform control in accordance with content of the event when the relay device detected the event in one of the second ports.

6. A method for controlling data transmission and reception performed by a data processing apparatus through a port, the method comprising:
configuring, on the data processing apparatus, a virtual interface for virtually performing data transmission and reception for each second port that is associated with a first port when the first port of a relay device including the first port and a plurality of second ports whose association relationships with the first port can be set arbitrarily is connected to the port; and
determining a virtual interface associated with a second port in which an event was detected, and performing control in accordance with content of the event when the relay device detected the event in one of the second ports.
